(19) United States
(12) Patent Application Publication
(10) Pub. No.: US 2006/0248745 A1
(43) Pub. Date: Nov. 9, 2006

(54) Fixed air knife assembly

(75) Inventors: Arvind D. Viswanath, Columbia, MO (US); Dennis M. Brunner, Centralia, MO (US); Daniel K. Luebbert, Columbia, MO (US); Bruce J. Kampeter, Freeburg, MO (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/120,683

(22) Filed: May 3, 2005

(51) Int. Cl. F26B 7/00

(52) U.S. Cl. 34/430

(57) ABSTRACT

An air knife apparatus for removing moisture from a moving web has a top tube, a bottom tube spaced parallel and at a fixed distance below the top tube to define a web path between the tubes, a connector permanently attached to a first end of the top tube and a first end of the bottom tube, and an air manifold permanently attached to a second end of the top tube and a second end of the bottom tube.

### FIELD

The present invention relates to an air knife apparatus for removing moisture from a moving web, and a method for forming the air knife apparatus. In particular, the present invention pertains to a unitary air knife apparatus that removes moisture from both sides of a moving web, and a method for forming the unitary air knife apparatus.

### BACKGROUND

During processing of a moving web of material, the web may be subjected to a variety of processing conditions, such as coating, curing, drying, stretching, converting, etc. An air knife assembly is often a part of a web processing line such as a horizontal wet-process circuit-making assembly line. The air knife assembly is frequently disposed along a section of the web processing line in order to sweep fluid off of a surface of the web, such as a circuit, and to dry the web by blowing hot air onto the surface of the web.

Current air knife assemblies, however, do not function as effectively and consistently as desired. First, they do not effectively remove moisture from the surface of the web. Therefore, when the web is dried by hot air, the remaining moisture on the web evaporates, resulting in a stain on the web. A web that contains a stain may be considered a defective product, resulting in a major source of yield loss. The failure to remove all the moisture is often due to a large distance between the air knife and the web, an inconsistent distance between the air knife and the web, or an inconsistent or improper angle of impingement of the air flow provided by the air knife.

Second, current air knife assemblies are difficult to remove for cleaning and difficult to replace after cleaning. To remove current air knife assemblies for cleaning, tools are often required. Therefore, because removal is an inconvenience, the air knife assembly may not be cleaned as often as it should be cleaned. Additionally, after removal, cleaning, and replacement, the air knife assembly may be replaced with misaligned angles and distances between the air knife and the web, leading to ineffective moisture removal.

### SUMMARY

In a first aspect, the present invention is directed to an air knife apparatus for removing moisture from the surface of a web. The air knife apparatus includes a top tube, a bottom tube, a connector and an air manifold. The top tube extends generally horizontally over a section of the web. The bottom tube is parallel to the top tube and is spaced a fixed distance below the top tube to define a web path therebetween. The top tube and the bottom tube have a plurality of openings for directing air onto top and bottom surfaces of the web, respectively. The connector and the air manifold are permanently attached to ends of the top tube and the bottom tube.

In a second aspect, the present invention is further directed to a method for forming an air knife apparatus. The method includes aligning a first pair of hollow elongated members in a parallel relationship, each hollow member having a first end and a second end and an interior air chamber, and a plurality of air outlet apertures extending linearly between the first end and the second end of each hollow member. Then, permanently affixing a common connector to the first end of each hollow member. Finally, permanently affixing a common manifold to the second end of each hollow member, the manifold having a cavity therein which is in fluid communication with the interior air chambers of both of the hollow members, with the hollow members being spaced apart a distance sufficient to define a non-contacting web flow path therebetween.

In a third aspect, the present invention is further directed to a method for simultaneously drying moisture on both major surfaces of a moving web that is traversing a web processing path. The method includes directing a top air drying curtain at the top surface of the web from a top air nozzle assembly, the top air drying curtain projecting in an upweb direction from a fixed distance from the top surface of the web. Then directing a bottom air drying curtain at the bottom surface of the moving web from a bottom air nozzle assembly, the bottom air drying curtain projecting in an upweb direction from a fixed distance from the bottom surface of the web. Finally, connecting the top and bottom air nozzle assemblies together to form a unitary air knife assembly having a horizontally aligned web travel path defined between the top and bottom air drying curtains of the top and bottom air nozzle assemblies, wherein the unitary air knife assembly is separably removable from the web processing path for service.

The above summary is not intended to describe each disclosed embodiment or every implementation of the present invention. The figures and the detailed description, which follow, more particularly exemplify illustrative embodiments.

### BRIEF DESCRIPTION OF THE DRAWINGS

The present invention will be further explained with reference to the drawing figures listed below, where like structure is referenced by like numerals throughout the several views.

FIG. 1 is a perspective view of an embodiment of an air knife apparatus of the present invention disposed along a horizontal section of a moving web.

FIG. 2 is a cross-sectional view of the air knife apparatus of FIG. 1, as taken along line 2-2 of FIG. 1.

FIG. 3 is a perspective view of the air knife apparatus of FIG. 1, shown spaced above its mounting brackets.

While the above-identified drawing figures set forth one embodiment of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale.

### DETAILED DESCRIPTION

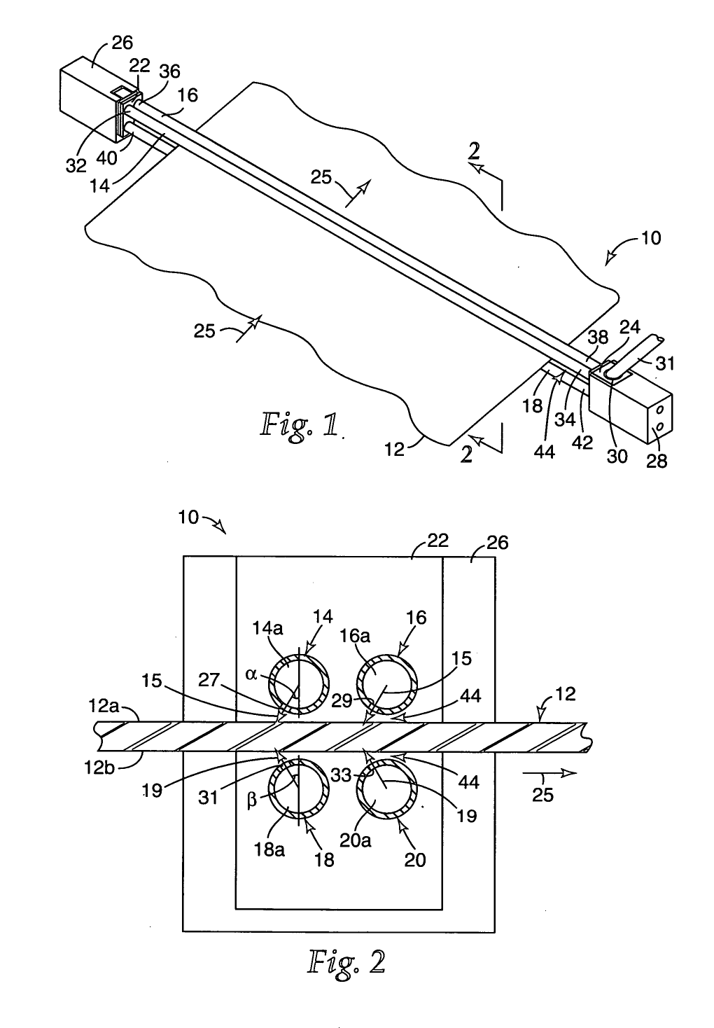

The present invention is an air knife apparatus for removing moisture from a surface of a moving web. FIG. 1 shows a perspective view of an embodiment of an air knife apparatus 10 of the present invention disposed along with a web processing line for acting on web 12. In this embodiment, the air knife apparatus 10 includes a first top tube 14, a second top tube 16, a first bottom tube 18, a second bottom tube 20 (not shown in FIG. 1), a common connector 22, a common air manifold 24 and a pair of mounting brackets 26 and 28.

The first top tube 14 and the second top tube 16 extend generally horizontally parallel to one another. The first bottom tube 18 and the second bottom tube 20 likewise extend generally horizontally parallel to one another. The first bottom tube 18 and the second bottom tube 20 are spaced at a fixed distance below the first top tube 14 and the second top tube 16 to define a web path 44 therebetween for the web 12. The first top tube 14, the second top tube 16, the first bottom tube 18 and the second bottom tube 20 are attached to the common connector 22 and the common air manifold 24. The common connector 22 and the common air manifold 24 are in turn, removably secured to the pair of mounting brackets 26 and 28. The mounting brackets 26 and 28 are secured relative to a web processing assembly that defines a web processing path traveled by the web 12. In one embodiment, the web path 44 is aligned to be generally horizontal along the web processing path. The common air manifold 24 has a cavity 30 therein for receiving air from a hose 31 connected to a pressurized air source (not shown). The cavity 30 transfers air to interior chambers 14a, 16a, 18a and 20a (FIG. 2) within the top tubes 14 and 16 and the bottom tubes 18 and 20, respectively.

The web 12 moves past the air knife apparatus 10 in the direction indicated by arrows 25 in FIGS. 1 and 2. Because of prior processing (not shown), the web 12 is wet as it approaches the air knife apparatus 10. The wet web 12 is advanced along the generally horizontal web path 44 between the top tubes 14 and 16 and the bottom tubes 18 and 20, and as the web 12 goes through the web path 44, the top tubes 14 and 16 and the bottom tubes 18 and 20 direct air onto the web 12 to remove moisture therefrom. As seen in FIG. 2, the top tubes 14 and 16 direct air in direction 15 onto a top surface 12a of the web 12, while the bottom tubes 18 and 20 direct air in direction 19 onto an opposite bottom surface 12b of the web 12. When the web 12 exits the web path 44, moisture has been removed from the top surface 12a and the bottom surface 12b of the web 12, resulting in a dry, or substantially dry, web 12. The web 12 then continues to move along its web processing path to the next station of the web processing assembly.

As seen in the exemplary embodiment illustrated in FIGS. 1-3, first top tube 14 and second top tube 16 are formed from elongated hollow cylindrical tubes. First top tube 14 extends generally horizontally, and has a first end 32, a second end 34 and an interior air chamber 14a. Second top tube 16 also extends generally horizontally, parallel to the first top tube 14. Second top tube 16 has a first end 36, a second end 38 and an interior air chamber 16a. Each of the top tubes has a row of linearly aligned openings extending between its first end and its second end, on an upstream side of the tube for directing air onto the top surface 12a of the web 12. As seen in FIG. 2, top tube 14 has openings 27 and top tube 16 has openings 29. The openings 27 and 29 of the top tubes 14 and 16 are oriented at an acute angle a relative to vertical. Thus, air is emitted from the openings 27 and 29 toward the top surface 12a of the moving web 12 in the direction indicated by arrows 15. Although a pair of top tubes 14 and 16 is shown, in some embodiments, only one top tube may be provided or used. (Or, in yet another embodiment, more than two top tubes may be provided or used).

As seen in the exemplary embodiment illustrated in FIGS. 1-3, first bottom tube 18 and second bottom tube 20 are formed from elongated hollow cylindrical tubes. The first bottom tube 18 is parallel and spaced at a fixed distance below the first top tube 14 to define a generally horizontal web path 44 therebetween. The distance between the first top tube 14 and the first bottom tube 18 must at least be equal to or greater than the thickness of the web 12 to allow the web 12 to pass through the web path 44. First bottom tube 18 has a first end 40, a second end 42 and an interior air chamber 18a. Second bottom tube 20 extends generally horizontally, parallel to the first bottom tube 18 and the second top tube 16. The second bottom tube 20 is spaced at a fixed distance below the second top tube 16 to further define the web path 44 therebetween. In one embodiment, the distance between the second top tube 16 and the second bottom tube 20 is the same distance between the first top tube 14 and the first bottom tube 18. Second bottom tube 20 has a first end (not shown), a second end (not shown) and an interior air chamber 20a. Each of the bottom tubes has a row of linearly aligned openings extending between its first end and its second end, on an upstream side of the tube for directing air onto the bottom surface 12b of the web 12. As seen in FIG. 2, bottom tube 18 has openings 31 and bottom tube 20 has openings 33. The openings 31 and 33 of the bottom tubes 18 and 20 are oriented at an acute angle β relative to vertical. Thus, air is emitted from the openings 31 and 33 toward the bottom surface 12b of the moving web 12 in the direction indicated by arrows 19. Although a pair of bottom tubes 18 and 20 is shown, in some embodiments, only one bottom tube may be provided or used. (Or, in yet another embodiment, more than two bottom tubes may be provided or used).

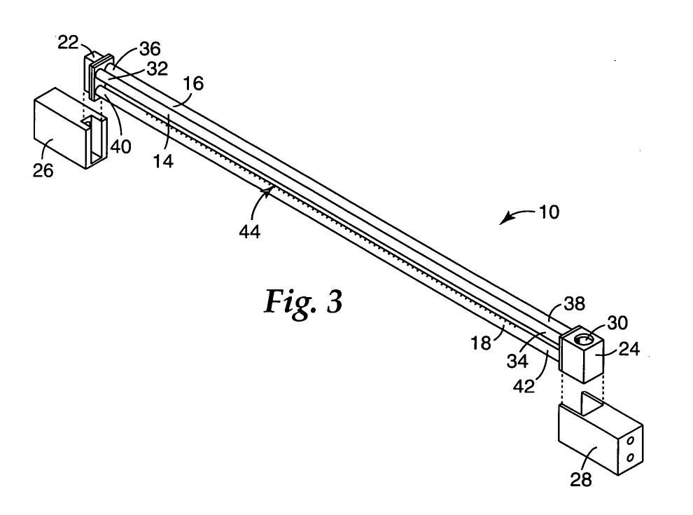

As shown in FIGS. 1 and 3, the common connector 22 is permanently attached to the first end 32 of the first top tube 14, the first end 36 of the second top tube 16, the first end 40 of the first bottom tube 18 and the first end (not shown) of the second bottom tube 20, such as by welding. The common connector 22 provides support to the top tubes 14 and 16 and the bottom tubes 18 and 20, and seals off the interior chambers 14a, 16a, 18a and 20a of each tube. The common connector 22 is shown as having a rectangular shape, however, any shape will work as long as the top tubes 14 and 16 and the bottom tubes 18 and 20 are supported and the first ends of the tubes are sealed.

As seen in FIGS. 1 and 3, the common air manifold 24 is permanently attached to the second end 34 of the first top tube 14, the second end 38 of the second top tube 16, the second end 42 of the first bottom tube 18 and the second end (not shown) of the second bottom tube 20, such as by welding. The common manifold 24 provides support to the top tubes 14 and 16 and the bottom tubes 18 and 20. The common air manifold 24 has a cavity 30 therein for receiving pressurized air from an air hose 31 connected thereto. The cavity 30 opens into the interior air chambers 14a, 16a, 18a and 20a of the tubes 14, 16, 18 and 20, respectively. Pressurized air from the air hose 31 flows into the cavity 30, which in turn distributes the air into the interior chambers 14a and 16a of the top tubes 14 and 16 and the interior chambers 18a and 20a of the bottom tubes 18 and 20. The air is then emitted out of the top tubes 14 and 16 through the openings 27 and 29 thereof, and out of the bottom tubes 18 and 20 through the openings 31 and 33 thereof to be directed at and impinge upon the surfaces 12a and 12b of the web 12. The common manifold 24 is shown as having a rectangular shape, however, any shape will work.

Mounting brackets 26 and 28 are secured to the web processing assembly by any suitable fastening means, such as by a friction fit or by mounting screws. Mounting brackets 26 and 28 are spaced apart laterally across the web flow path 44 at a width to suit the width of the web processing assembly. For example, typical web widths may be 8, 12, 14, 20 or 30 inches (2.03, 3.05, 3.56. 5.08 or 7.62 decimeters), and typical web thickness may be 2-3 mils (0.005-0.076 millimeters). The width of the mounting brackets 26 and 28 can be easily modified to suit different web processing assembly widths so that the air knife apparatus 10 can be used with various web processing assemblies.

As shown in FIG. 3, mounting brackets 26 and 28 are formed for receiving the common connector 22 and the common air manifold 24. The common connector 22 is secured to the mounting bracket 26, such as by sliding the common connector 22 into the mounting bracket 26, to secure the air knife apparatus 10 relative to the web processing assembly. The common air manifold 24 is secured to the mounting bracket 28, such as by sliding the common air manifold 24 into the mounting bracket 28, to secure the air knife apparatus 10 relative to the web processing assembly. Once the common connector 22 and the common manifold 24 are secured to their respective mounting brackets 26 and 28, the position of the air knife apparatus 10 is fixed with respect to the web processing path 44 (resulting in little possibility of positioning of the air knife apparatus 10 in an incorrect location relative to the desired web travel path). Additionally, the distance between the top tubes 14 and 16 and the top surface 12a of the web 12 and the bottom tubes 18 and 20 and the bottom surface 12b of the web 12 is thus fixed and cannot be altered, allowing for effective moisture removal at all times. In addition, the angle of impingement of the air emitted from the openings 27 and 29 of the top tubes 14 and 16 and the opening 31 and 33 of the bottom tubes 18 and 20 is fixed relative to the web surfaces and thus cannot be changed, resulting in more consistent and effective moisture removal at all times. Because the common connector 22 and the common manifold 24 slide into the mounting brackets 26 and 28, no tools are required to remove or mount the top tubes 14 and 16 and the bottom tubes 18 and 20 and, therefore, the air knife apparatus 10 can be easily cleaned and serviced.

In one embodiment of the present invention, each of the top tubes 14 and 16 and each of the bottom tubes 18 and 20 is made from a stainless steel material such as 316 stainless steel. Also, each of the top tubes 14 and 16 and each of the bottom tubes 18 and 20 have an outside tube diameter of ⅜ inch (9.53 millimeters) and an inside tube diameter of 0.277 inch (7.036 millimeters). The vertical distance between the openings of the top tubes 14 and 16 and the top surface 12a of the passing web 12 is about ⅛ inch (3.175 millimeters). The vertical distance between the openings of the bottom tubes 18 and 20 and the bottom surface 12b of the passing web 12 is about ⅛ inch (3.175 millimeters). The common connector 22 and the common manifold 24 are made from a stainless steel material such as 316 stainless steel. Additionally, the mounting brackets 26 and 28 are made from a polymeric material such as polyvinyl chloride.

In one embodiment, each of the top tubes 14 and 16 and each of the bottom tubes 18 and 20 have 79 linearly aligned circular openings extending between its first end and its -second end, on an upstream side of the tube, for directing air onto the respective surface of the web 12. In one embodiment, the openings allow a sufficient amount of air to be directed onto the surface of the web 12 to achieve effective removal of moisture. In one embodiment, each of the linearly aligned openings is circular, having a diameter of about 1/32 inch (0.795 millimeters). These openings are spaced about ¼ inch (6.350 millimeters) apart, measuring from the center of one opening to the center of an adjacent opening. The openings of each of the tubes are oriented at an acute angle from as shallow as about five degrees (0.0873 radians), or even about eight degrees (0.1396 radians), relative to vertical. The openings could also be oriented at an acute angle up to about 12 degrees (0.2094 radians), or even about fifteen degrees (0.2618 radians), relative to vertical.

Although the present invention has been described with reference to preferred embodiments, workers skilled in the art will recognize that changes may be made in form and detail without departing from the spirit and scope of the invention.

1. An air knife apparatus for removing moisture from a top surface and an opposite bottom surface of a generally horizontal section of a moving web, the air knife apparatus comprising:
a top tube generally horizontally extending over the horizontal section of the web, the top tube having a plurality of linearly aligned openings for directing air onto the top surface of the web;
a bottom tube spaced at a fixed distance below the top tube to define a web path therebetween for the generally horizontal section of the web, the bottom tube being parallel to the top tube, and the bottom tube having a plurality of linearly aligned openings for directing air onto the bottom surface of the web;
a connector permanently attached to a first end of the top tube and a first end of the bottom tube for supporting the top tube and the bottom tube; and
an air manifold permanently attached to a second end of the top tube and a second end of the bottom tube for supporting the top tube and the bottom tube, wherein the manifold has a cavity for receiving air which is in fluid communication with the openings in the top and bottom tubes.

2. The air knife apparatus of claim 1, wherein the air knife apparatus further comprises:
a pair of mounting brackets adapted for receiving the connector and the manifold, wherein the pair of mounting brackets secure the air knife apparatus relative to a processing path traversed by the moving web.

3. The air knife apparatus of claim 1, wherein the plurality of openings of the top tube and the plurality of openings of the bottom tube are each oriented at an angle from about five degrees to about fifteen degrees relative to vertical, on an upweb side of each tube.

4. The air knife apparatus of claim 1, wherein the plurality of openings of the top tube and the plurality of openings of the bottom tube are each oriented at an angle from about eight degrees to about twelve degrees relative to vertical, on an upweb side of each tube.

5. The air knife apparatus of claim 1, wherein the top tube is a first top tube, wherein the bottom tube is a first bottom tube, and wherein air knife apparatus further comprises:
a second top tube extending over the generally horizontal section of the web, the second top tube extending parallel to the first top tube, and the second top tube having a plurality of linearly aligned openings for directing air onto the top surface of the web which are spaced from the top surface of the web at a same distance as the openings of the first top tube; and
a second bottom tube spaced at the fixed distance below the second top tube to define a web path therebetween for the generally horizontal section of the web, the second bottom tube being parallel to the second top tube and to the first bottom tube, and the second bottom tube having a plurality of linearly aligned openings for directing air onto the bottom surface of the web which are spaced from the bottom surface of the web at a same distance as the openings of the first bottom tube.

6. The air knife apparatus of claim 5, wherein the connector is permanently attached to a first end of the second top tube and a first end of the second bottom tube for supporting the second top tube and the second bottom tube.

7. The air knife apparatus of claim 5, wherein the air manifold is permanently attached to a second end of the second top tube and a second end of the second bottom tube for supporting the second top tube and the second bottom tube, wherein the cavity of the manifold is in fluid communication with the openings in the second top and bottom tubes.

8. A method for forming an air knife apparatus, the method comprising:
aligning a first pair of hollow elongated members in a parallel relationship, each hollow member having a first end and a second end and an interior air chamber, and a plurality of air outlet apertures extending linearly between the first end and second end of each hollow member;
permanently affixing a common connector to the first end of each hollow member; and
permanently affixing a common manifold to the second end of each hollow member, the manifold having a cavity therein which is in fluid communication with the interior air chambers of both of the hollow members, with the hollow members being spaced apart a distance sufficient to define a non-contacting web flow path therebetween.

9. The method of claim 8, wherein the web flow path is generally horizontal, and including the step of:
aligning the air outlet apertures to emit air therefrom at an angle from about five degrees to about fifteen degrees relative to vertical, on an upweb side of each hollow member.

10. The method of claim 8, wherein the web flow path is generally horizontal, and including the step of:
aligning the air outlet apertures to emit air therefrom at an angle from about eight degrees to about twelve degrees relative to vertical, on an upweb side of each hollow member.

11. The method of claim 8, including the step of:
forming the first pair of hollow elongated members from cylindrical tubes.

12. The method of claim 8, including the step of:
securing the affixed common connector and the affixed common manifold onto a pair of mounting brackets to position the web flow path along a web processing path to be traversed by a moving web.

13. The method of claim 8, including the step of:
aligning a second pair of hollow elongated members in a parallel relationship and adjacent to the first pair of hollow members, each hollow member of the second pair having a first end and a second end and an interior air chamber, and a plurality of air outlet apertures extending linearly between the first and second end of each second hollow member;
permanently affixing the common connector to a first end of each hollow member of the second pair; and
permanently affixing the common manifold to a second end of each hollow member of the second pair, wherein the cavity of the manifold is in fluid communication with the interior air chambers of both of the hollow members of the second pair, with the hollow members of the second pair being spaced apart the same distance as the hollow members of the first pair.

14. The method of claim 13, including the step of:
securing the affixed common connector and the affixed common manifold onto a pair of mounting brackets to position the web flow path.

15. A method for simultaneously drying moisture on both major surfaces of a moving web which is traversing a web processing path, the method comprising:
directing a top air drying curtain at the top surface of the moving web from a top air nozzle assembly, the top air drying curtain projecting in an upweb direction from a fixed distance from the top surface of the web;
directing a bottom air drying curtain at the bottom surface of the moving web from a bottom air nozzle assembly, the bottom air drying curtain projecting in an upweb direction from a fixed distance from the bottom surface of the web; and
connecting the top and bottom air nozzle assemblies together to form a unitary air knife assembly having a horizontally aligned web travel path defined between the top and bottom air drying curtains of the top and bottom air nozzle assemblies, wherein the unitary air knife assembly is separably removable from the web processing path for service.

16. The method of claim 15, and further comprising:
forming each air nozzle assembly from a cylindrical tube.

17. The method of claim 16, and further comprising:
forming the air drying curtains from linearly aligned openings in the tubes.

18. The method of claim 15, and further comprising:
projecting each of the air drying curtains at an angle from about five degrees to about fifteen degrees relative to vertical.

19. The method of claim 15, and further comprising:
projecting each of the air drying curtain at an angle from about eight degrees to about twelve degrees relative to vertical.

20. The method of claim 15, and further comprising:
providing mounting brackets along the web travel path adapted to selectively receive the air knife assembly and position the web travel path of the air knife assembly in place along the web processing path.
